(19) United States
(12) Patent Application Publication
(10) Pub. No.: US 2026/0121833 A1
(43) Pub. Date: Apr. 30, 2026

(54) METHOD FOR COMPARING TRAFFIC PARAMETERS, DEVICE, SYSTEM AND STORAGE MEDIUM

(71) Applicant: CHINA UNIONPAY CO., LTD., Shanghai (CN)

(72) Inventors: Qi WANG, Shanghai (CN); Pengfei GAO, Shanghai (CN); Yongkai ZHOU, Shanghai (CN); Gaolei ZHANG, Shanghai (CN); Zhongzheng CHEN, Shanghai (CN); Yadan DING, Shanghai (CN)

(21) Appl. No.: 19/479,271

(22) PCT Filed: Mar. 20, 2024
(86) PCT No.: PCT/CN2024/082607

§ 371 Date: Oct. 27, 2025

(30) Foreign Application Priority Data
Apr. 27, 2023 (CN) 202310475271.1

(51) Int. Cl. H04L 9/06; G06F 21/60

(52) U.S. Cl. CPC H04L 9/0618; G06F 21/602

(57) ABSTRACT

The present application discloses a method for comparing service parameters, device, system, and storage medium, belonging to the field of big data processing. The method includes: obtaining a first interaction string and a first result string based on a first binary string converted from a first service parameter of a first device, randomly generated first label strings, and agreed initial random strings; sending the first interaction string to a second device, so that the second device obtains a second result string based on a second binary string converted from a second service parameter of the second device, the initial random strings, part of randomly generated second label strings, and the first interaction string; and interacting with the second device based on the first result string and the second result string for fragmented computation to obtain a first comparison result.

### CROSS REFERENCE TO RELATED APPLICATION

This application is a National Stage of International Application No. PCT/CN2024/082607, filed on Mar. 20, 2024, which claims priority to Chinese Patent Application No. 202310475271.1, filed on Apr. 27, 2023 and entitled “METHOD FOR COMPARING SERVICE PARAMETERS, DEVICE, SYSTEM AND STORAGE MEDIUM”,

both of which are hereby incorporated by reference in its entireties.

### TECHNICAL FIELD

The present application belongs to the field of big data processing, and in particular, relates to a method for comparing service parameters, device, system, and storage medium.

### BACKGROUND

With the continuous development of information technology, more and more service scenarios require multi-party participation, such as service scoring, machine learning, service data statistics, and sorting. In order to ensure the security of information of multiple parties participating in the same service scenario, privacy computation technology has been introduced.

In the process of privacy computation, devices of different parties may encrypt information into ciphertexts before transmission, and perform logical computations in the ciphertext state to prevent information leakage. In some cases, in order to implement a service, service parameters of different parties need to be compared. In order to ensure the privacy security of service parameters, actual service parameters are not transmitted, but a large amount of data transmission and interaction are required between multiple parties.

### SUMMARY

In a first aspect, some embodiments of the present application provide a method for comparing service parameters, applied to a first device, the method including: obtaining a first interaction string and a first result string based on a first binary string converted from a first service parameter of the first device, 2^{N} randomly generated first label strings, and 2^{N} initial random strings agreed by the first device and a second device, where the first binary string includes 2^{N}bits, and N is a positive integer; sending the first interaction string to the second device, so that the second device obtains a second result string based on a second binary string converted from a second service parameter of the second device, the initial random strings, part of randomly generated second label strings, and the first interaction string, where the second binary string includes 2^{N} bits; and interacting with the second device based on the first result string and the second result string for fragmented computation to obtain a first comparison result, where the first comparison result represents whether the first service parameter is equal to the second service parameter.

In a second aspect, some embodiments of the present application provide a method for comparing service parameters, applied to a second device, the method including: receiving a first interaction string sent by a first device, where the first interaction string is obtained by the first device based on N randomly generated first label strings; obtaining a second result string based on a second binary string converted from a second service parameter of the second device, initial random strings, part of randomly generated second label strings, and the first interaction string, where the second binary string includes 2^{N} bits, and N is a positive integer; and interacting with the first device based on a first result string and the second result string for fragmented computation to obtain a first comparison result, where the first result string is obtained by the first device based on a first binary string converted from a first service parameter of the first device, the first label strings, and N initial random strings agreed by the first device and the second device, where the first comparison result represents whether the first service parameter is equal to the second service parameter, and the first binary string includes 2^{N} bits.

In a third aspect, some embodiments of the present application provide a first device, including: a local computation module, configured to obtain a first interaction string and a first result string based on a first binary string converted from a first service parameter of the first device, 2randomly generated first label strings, and 2^{N} initial random strings agreed by the first device and a second device, where the first binary string includes 2^{N} bits, and N is a positive integer; and a communication module, configured to send the first interaction string to the second device, so that the second device obtains a second result string based on a second binary string converted from a second service parameter of the second device, the initial random strings, part of randomly generated second label strings, and the first interaction string, where the second binary string includes 2^{N} bits; where the communication module and the local computation module are further configured to interact with the second device based on the first result string and the second result string for fragmented computation to obtain a first comparison result, where the first comparison result represents whether the first service parameter is equal to the second service parameter.

In a fourth aspect, some embodiments of the present application provide an electronic device, including: a processor and a memory storing computer program instructions; where the processor, when executing the computer program instructions, implements the method for comparing service parameters in the first aspect or the method for comparing service parameters in the second aspect.

In a fifth aspect, some embodiments of the present application provide a system for comparing service parameters, including: a first device, configured to perform the method for comparing service parameters in the first aspect; and a second device, configured to perform a method for comparing service parameters that is applied to the second device and includes: receiving a first interaction string sent by a first device, wherein the first interaction string is obtained by the first device based on N randomly generated first label strings; obtaining a second result string based on a second binary string converted from a second service parameter of the second device, initial random strings, part of randomly generated second label strings, and the first interaction string, wherein the second binary string comprises 2N bits, and N is a positive integer; and interacting with the first device based on a first result string and the second result string for fragmented computation to obtain a first comparison result, wherein the first result string is obtained by the first device based on a first binary string converted from a first service parameter of the first device, the first label strings, and N initial random strings agreed by the first device and the second device, the first comparison result represents whether the first service parameter is equal to the second service parameter, and the first binary string comprises 2N bits.

In a sixth aspect, some embodiments of the present application provide a computer-readable storage medium, the computer-readable storage medium storing computer program instructions, and the computer program instructions, when executed by a processor, implementing the method for comparing service parameters in the first aspect or the method for comparing service parameters in the second aspect.

### BRIEF DESCRIPTION OF THE DRAWINGS

In order to explain the technical solutions of the embodiments of the present application more clearly, the accompanying drawings required for use in the embodiments of the present application will be briefly introduced below. A person of ordinary skill in the art may derive other drawings based on these drawings without any creative effort.

FIG. 1 is a schematic diagram of a system architecture of an example of a method for comparing service parameters according to an embodiment of the present application;

FIG. 2 is a flowchart of a method for comparing service parameters according to an embodiment in a first aspect of the present application;

FIG. 3 is a flowchart of a method for comparing service parameters according to another embodiment in the first aspect of the present application;

FIG. 4 is a flowchart of a method for comparing service parameters according to still another embodiment in the first aspect of the present application;

FIG. 5 is a flowchart of a method for comparing service parameters according to an embodiment in a second aspect of the present application;

FIG. 6 is a flowchart of a method for comparing service parameters according to another embodiment in the second aspect of the present application;

FIG. 7 is a flowchart of a method for comparing service parameters according to still another embodiment in the second aspect of the present application;

FIG. 8 is a schematic curve diagram of an example of a rectified linear unit according to some embodiments of the present application;

FIG. 9 is a schematic structural diagram of a first device according to an embodiment in a third aspect of the present application;

FIG. 10 is a schematic structural diagram of a second device according to an embodiment in a fourth aspect of the present application; and

FIG. 11 is a schematic structural diagram of an electronic device according to an embodiment in a fifth aspect of the present application.

### DETAILED DESCRIPTION

Features and exemplary embodiments of various aspects of the present application will be described in detail below. In order to make the objectives, technical solutions, and advantages of the present application clearer, the present application will be further described in detail below with reference to the accompanying drawings and specific embodiments. It should be understood that the specific embodiments described here are merely intended to explain the present application, but not to limit the present application. For those skilled in the art, the present application may be implemented without some of these specific details. The following descriptions of the embodiments are merely for providing a better understanding of the present application by showing examples of the present application. It should be noted that the acquisition, storage, use, processing, etc. of information and data in the embodiments of the present application are authorized by users or relevant institutions and comply with relevant national laws and regulations.

With the continuous development of information technology, more and more service scenarios require multi-party participation, such as service scoring, machine learning, service data statistics, and sorting. In order to ensure the security of information of multiple parties participating in the same service scenario, privacy computing technology has been introduced. In the process of privacy computation, devices of different parties may encrypt information into ciphertexts before transmission, and perform logical computations in a ciphertext state to prevent information leakage. In some cases, in order to implement a service, service parameters of different parties need to be compared. In order to ensure the privacy security of service parameters, actual service parameters are not transmitted, but a large amount of data transmission and interaction are required between multiple parties. However, the large amount of data transmission and interaction takes a long time, thereby reducing the efficiency of service parameter comparison.

For example, secure multi-party computation is implemented based on a confusion circuit. Relevant data of service parameters is L-bit data, and L full adders are correspondingly configured in the confusion circuit. In the computation process of each full adder, both party A and party B that hold service parameters need to perform multiple times of interactive communication. In the presence of the L full adders, the interactive communication between party A and party B increases exponentially. The more interactive communication, the longer the time occupied by the interactive communication, and the lower the efficiency of service parameter comparison.

For another example, secure multi-party computation is implemented in a secret sharing manner. The secret sharing needs to execute an A2B protocol. The A2B protocol needs to convert one sharing from arithmetic sharing to Boolean sharing. The operational performance of the A2B protocol mainly depends on a selected addition circuit, such as an addition circuit with a Kogge-stone structure or a Sklansky structure. However, the addition circuit involves numerous executions, and the processing of each bit of relevant data of service parameters in the addition circuit requires a large amount of interactive communication between party A and party B that hold the service parameters. Each carry involved in the addition circuit also requires a large amount of interactive communication between party A and party B. The large amount of interactive communication reduces the efficiency of service parameter comparison.

Embodiments of the present application provide a method for comparing service parameters, device, system, and storage medium, where local computation is combined with secure multi-party computation (MPC), and most operations associated with service parameter comparison are executed locally by both parties participating in the service parameter comparison, without homomorphic encryption and decryption or additional auxiliary parties, thereby reducing communication interactions between both parties participating in the service parameter comparison, minimizing interactive communication time for the secure multi-party computation, and improving the efficiency of service parameter comparison.

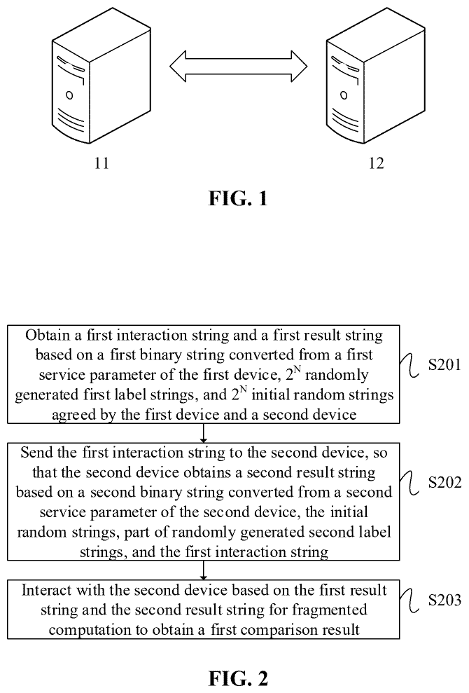

The method for comparing service parameters according to the embodiments of the present application may be used to compare service parameters between both parties, and may also be used to compare service parameters between more parties. In a scenario of service parameter comparison between more parties, any two parties in the more parties may employ the method for comparing service parameters according to the embodiments of the present application. For ease of explanation, in the embodiments of the present application, a device of one party that performs the method for comparing service parameters is referred to as a first device, while a device of the other party that performs the method for comparing service parameters is referred to as a second device. FIG. 1 is a schematic diagram of a system architecture of an example of a method for comparing service parameters according to an embodiment of the present application. As shown in FIG. 1, the system architecture includes a first device 11 and a second device 12, the first device 11 belongs to a first party, the second device 12 belongs to a second party, and the first party is different from the second party. The first device 11 and the second device 12 may communicate interactively, but in the embodiments of the present application, most computations related to service parameters of the first device 11 in the process of comparing service parameters are performed locally in the first device 11. Similarly, most computations related to service parameters of the second device 12 in the process of comparing service parameters are performed locally in the second device 12. The first device 11 and the second device 12 may be user terminals, servers, or the like. Types of the first device 11 and the second device 12 are not limited here.

Below are explanations of the method for comparing service parameters, device, system, and storage medium according to the present application.

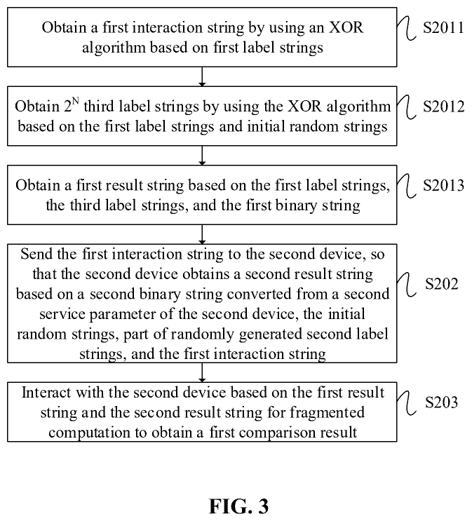

A first aspect of the present application provides a method for comparing service parameters, which may be applied to a first device, that is, the method for comparing service parameters may be performed by the first device. FIG. 2 is a flowchart of a method for comparing service parameters according to an embodiment in a first aspect of the present application. As shown in FIG. 2, the method for comparing service parameters may include steps S201 to S203.

In step S201, a first interaction string and a first result string are obtained based on a first binary string converted from a first service parameter of the first device, 2^{N} randomly generated first label strings, and 2^{N} initial random strings agreed by the first device and a second device.

The first service parameter includes service parameters of a first party to which the first device belongs. The service parameters may be used in various service implementation scenarios, such as service scoring, machine learning, service model training, service data statistics, and sorting. Specific types of the service parameters are not limited here.

The first binary string is a binary string converted from the first service parameter. The first binary string includes 2^{N} bits, where N is a positive integer. For example, the first binary string may include 4 bits, 8 bits, 16 bits, 32 bits, 64 bits, or more bits, which may be configured according to application scenario, requirements, etc. In some examples, to improve the accuracy of service parameter comparison, N≥4.

The first label strings are randomly generated by the first device, and the quantity of first label strings is the same as the quantity of bits in the first binary string. For example, the first binary string includes 4 bits. Correspondingly, the first device randomly generates 4 first label strings. Each bit in the first binary string corresponds to one first label string. The first label strings may be used to identify values of the corresponding bits in the first binary string. In some examples, the quantity of bits in each first label string is the same as the quantity of bits in the first binary string, without limitation here.

The initial random strings are randomly generated string predetermined by the first device and the second device, and the initial random strings in the first device are the same as the initial random strings in the second device. In some examples, a Diffie-Hellman (DH) algorithm may be used to complete key exchange between the first device and the second device without directly transmitting original keys, thereby obtaining a shared random number seed, where the random number seed may be used to generate an initial random string in the first device and the second device respectively. That is, the first device generates an initial random string by using the random number seed, and the second device also generates an initial random string by using the random number seed. The quantity of initial random strings is the same as the quantity of bits in the first binary string and the quantity of bits in a second binary string. For example, the first device may select one prime number p, one base number g, and one random number a, and then compute A=g^{a} (mod p). The first device sends the prime number p, the base number g, and the computed A to the second device. The second device may select one random number b, and compute B=g^{b} (mod p) and s1=Ab (mod p). The second device may send the computed B to the first device. The first device computes s2-Ba (mod p). The s2 computed by the first device is equal to the s1 computed by the second device, and the s1 may be used as a random number seed. For example, p=509, g-5, a=123, and b=456, then A=215, B=181, and s1 =s2=121 may be obtained by computing, and 121 may be used as a random number seed. It should be noted that the random number seed s1 is not transmitted between the first device and the second device, and the s1 cannot be inferred from the A and B computed through the prime number p and base number g transmitted between the first device and the second device, thereby ensuring the security of the random number seed. Because the first device and the second device obtain the shared random number seed by using the DH algorithm, the distribution of initial random strings is not required, thereby further reducing communication interactions between the first device and the second device and further improving the efficiency of service parameter comparison.

By computing the first binary string, the first label strings, and the initial random strings, the first interaction string and the first result string may be obtained. Specifically, the first interaction string and the first result string may be obtained by using an XOR algorithm based on the first binary string, the first label strings, and the initial random strings. The computation of obtaining the first interaction string and the first result string is performed locally in the first device, without generating interaction with the second device, thereby greatly saving the time spent on communication interaction for the first device.

The first interaction string may be obtained based on the first label strings. The first interaction string may be provided to the second device, so that the second device obtains the second result string based on the first interaction string and information generated by the second device. The first device may establish an association with the second device by using the first interaction string. It should be noted that the first interaction string cannot be used to derive the first service parameter, which can ensure the privacy security of the first service parameter.

The first result string may be obtained based on the first label strings, the initial random strings, and the first binary string. The first result string may represent the first binary string, but the first binary string cannot be reversely deduced from the first result string. The first result string may be used for fragmented computation with a second result string generated by the second device to determine whether the first service parameter is equal to a second service parameter in the second device.

It should be noted that the first label strings, the initial random strings, the first interaction string, and the first result string are all binary strings.

In step S202, the first interaction string is sent to the second device, so that the second device obtains a second result string based on a second binary string converted from a second service parameter of the second device, the initial random strings, part of randomly generated second label strings, and the first interaction string.

The first device performs a communication interaction with the second device in step S202 and sends the first interaction string to the second device. After receiving the first interaction string, the second device may obtain the second result string based on the second binary string, the initial random strings, part of the randomly generated second label strings, and the received first interaction string.

The second service parameter includes service parameters of a second party to which the second device belongs. The specific content of the service parameters may be referenced to the relevant explanation in the foregoing embodiment, and will not be repeated here.

The second binary string is a binary string converted from the second service parameter. The second binary string includes 2^{N} bits, and the quantity of bits in the second binary string is the same as the quantity of bits in the first binary string.

The initial random strings in the second device are the same as the initial random strings in the first device. The specific content may be referenced to the relevant explanation in the foregoing embodiment, and will not be repeated here.

Part of second label strings in the second device are randomly generated by the second device, while the other part are obtained based on the part of randomly generated second label strings and the received first interaction string. The quantity of second label strings is the same as the quantity of bits in the second binary string. In some examples, the second device randomly generates (2^{N}−1) second label strings. The randomly generated second label strings may include a 1^{st} second label string to a (2^{N}−1)th second label string. The (2^{N})^{th} second label string may be obtained based on the 1^{st} second label string to the (2^{N}−1)^{th} second label string and the first interaction string. For example, the second binary string includes 4 bits. Correspondingly, the second device randomly generates 3 second label strings. The 4^{th} second label string may be obtained based on the first 3 randomly generated second label strings and the first interaction string. Each bit in the second binary string corresponds to one second label string. The second label strings may be used to identify values of the corresponding bits in the second binary string. In some examples, the quantity of bits in each second label string is the same as the quantity of bits in the second binary string, without limitation here.

The second result string may be obtained based on the second binary string, the initial random strings, the randomly generated second label strings, and the first interaction string. The second result string may represent the second binary string, but the second binary string cannot be reversely deduced from the second result string. The second result string may be used for fragmented computation with the first result string generated by the first device to determine whether the second service parameter is equal to the first service parameter in the first device.

It should be noted that both the second label strings and the second result string are binary strings.

In step S203, the first device interacts with the second device based on the first result string and the second result string for fragmented computation to obtain a first comparison result.

The fragmented computation may include fragmented subtraction. The first device may fragment the first result string, and the second device may fragment the second result string. The first device and the second device perform a fragmented subtraction of secure multi-party computation to obtain the first comparison result. The first comparison result may represent whether the first result string is equal to the second result string, thereby representing whether the first service parameter is equal to the second service parameter. The fragmented computation merely involves a few communication interactions between the first device and the second device, resulting in very few communication interactions. For example, the first device may fragment the first result string to obtain a first fragment and a second fragment, and a sum of the first fragment and the second fragment is the first result string; the second device fragments the second result string to obtain a third fragment and a fourth fragment, and a sum of the third fragment and the fourth fragment is the second result string; the first device exchanges the first fragment and the third fragment with the second device; the first device computes a first difference between the first fragment and the third fragment; the second device computes a second difference between the fourth fragment and the second fragment; the first device sends the first difference to the second device, or the second device sends the second difference to the first device; the first device or the second device computes a difference between the first difference and the second difference; if the difference is zero, the first comparison result represents that the first service parameter is equal to the second service parameter; and if the difference is not zero, the first comparison result represents that the first service parameter is unequal to the second service parameter.

In the embodiment of the present application, the first device computes the first interaction string and the first result string locally based on the first binary string converted from the first service parameter thereof, the first label strings, and the initial random strings, and the first device sends the first interaction string to the second device. The second device computes the second result string locally based on the second binary string converted from the second service parameter thereof, the second label strings, the initial random strings, and the first interaction string. The first device interacts with the second device based on the first result string and the second result string for fragmented computation to obtain the first comparison result indicating whether the first service parameter is equal to the second service parameter. Most of the computations in the entire process are performed locally in both the first device and the second device, and there is merely a very small amount of communication interaction between the first device and the second device during the transmission of the first interaction string and the fragmented computation, thereby reducing communication interactions between the first device and the second device and improving the efficiency of multi-party service parameter comparison. Moreover, plaintexts of the first service parameter in the first device and the second service parameter in the second device terminal will not be leaked, thereby ensuring privacy security and making the method very suitable for scenarios such as federated learning and secure handover.

In some embodiments, the XOR algorithm may be used to compute the first interaction string and the first result string. FIG. 3 is a flowchart of a method for comparing service parameters according to another embodiment in the first aspect of the present application. FIG. 3 differs from FIG. 2 in that step S201 in FIG. 2 may be specifically refined into steps S2011 to S2013 in FIG. 3.

In step S2011, a first interaction string is obtained by using an XOR algorithm based on first label strings.

The quantity of first label strings is the same as the quantity of bits in a first binary string. XOR computation may be performed on the 2^{N} first label strings to obtain the first interaction string. For example, N=2. The first device randomly generates 4 first label strings: a0_0, a1_0, a2_0, and a3_0. Then, the first interaction string is a_0=a0_0 ⊕ a1_0 ⊕ a2_a3_0, where ⊕ represents an XOR computation symbol.

In step S2012, 2^{N} third label strings are obtained by using the XOR algorithm based on the first label strings and initial random strings.

The first label strings may represent that values of the corresponding bits in the first binary string are 0. The third label strings may represent that values of the corresponding bits in the first binary string are 1. The quantity of initial random strings is the same as the quantity of bits in the first binary string. XOR computation may be performed on the first label string corresponding to each bit of the first binary string and the initial random string to obtain the third label string corresponding to each bit of the first binary string. For example, N=2. The first device randomly generates 4 first label strings: a0_0, a1_0, a2_0, and a3_0; the first device randomly generates 4 initial random strings: r0, r1, r2, and r3; then, the 4 generated third label strings are a0_1, a1_1, a2_1, and a3_1, where a0_1=a0_0 ⊕ r0, a1_1=a1_0 ⊕ r1, a2_1=a2_0 ⊕ r2, and a3_1=a⊕ r3; the bits of the first binary string from left to right are the first to fourth bits; a0_0, a0_1, and r0 correspond to the first bit of the first binary string; a1_0, a1_1, and r1 correspond to the second bit of the first binary string; a2_0, a2_1, and r2 correspond to the third bit of the first binary string; and a3_0, a3_1, and r3 correspond to the fourth bit of the first binary string.

In step S2013, a first result string is obtained based on the first label strings, the third label strings, and the first binary string.

The value of each bit in the first binary string is 0 or 1. The first label strings and/or third label strings used for XOR computation may be determined based on the values of the bits in the first binary string. Specifically, the first device may select the first label strings and/or third label strings corresponding to the values of the bits in the first binary string, and obtain the first result string by using the XOR algorithm based on the selected first label strings and/or third label strings.

If the value of a bit in the first binary string is 0, the first label string corresponding to the bit is selected; and if the value of a bit in the first binary string is 1, the third label string corresponding to the bit is selected. The XOR algorithm is performed on the selected first label strings and/or third label strings to obtain the first result string. For example, N=2. Corresponding to the four bits of the first binary string, the first label strings are a0_0, a1_0, a2_0, and a3_0, and the third label strings are a0_1, a1_1, a2_1, and a3_1. If the first binary string is 0001, the value of the first bit is 0, the first label string a0_0 is selected, the value of the second bit is 0, the first label string a1_0 is selected, the value of the third bit is 0, the first label string a2_0 is selected, the value of the fourth bit is 1, the third label string a3_1 is selected, and the first result string is za=a0_0 ⊕ a1_0 ⊕ a2_0 ⊕ a3_1.

In some embodiments, the second result string is obtained by the second device based on the second label strings, fourth label strings, and the second binary string. The second label strings represent that values of the corresponding bits in the second binary string are 0. Part of the second label strings are obtained by using the XOR algorithm based on the other part of the randomly generated second label strings and the first interaction string. The fourth label strings represent that values of the corresponding bits in the second binary string are 1. The fourth label strings are obtained by the second device using the XOR algorithm based on the second label strings and the initial random strings.

The quantity of second label strings is the same as the quantity of bits in the second binary string. The second device randomly generates a 1^{st} second label string to a (2^{N}−1)^{th} second label string, and performs XOR computation on the 1^{st} second label string to the (2^{N}−1)^{th} second label string and the first interaction string to obtain (2^{N})^{th} second label strings. For example, N=2, and the first interaction string is a_0. The second device randomly generates 3 second label strings: b0_0, b1_0, and b2_0. Then, the 4^{th} second label string is b3_0=b0_0 ⊕ b1_0 ⊕ b2_0 ⊕ a_0.

XOR computation may be performed on the second label string corresponding to each bit of the second binary string and the initial random string to obtain the fourth label string corresponding to each bit of the second binary string. For example, N=2, the initial random strings are r0, r1, r2, and r3, and the second label strings are b0_0, b1_0, b2_0, and b3_0. Then, the 4 generated fourth label strings are b0_1, b1_1, b2_1, and b3_1, where b0_1=b0_0 ⊕ r0, b1_1=b1_0 ⊕ r1, b2_1=b2_0 ⊕ r2, and b3_1=b3_0 ⊕ r3. The bits of the second binary string from left to right are the first to fourth bits; b0_0, b0_1, and r0 correspond to the first bit of the second binary string; b1_0, b1_1, and r1 correspond to the second bit of the second binary string; b2_0, b2_1, and r2 correspond to the third bit of the second binary string; and b3_0, b3_1, and r3 correspond to the fourth bit of the second binary string.

The value of each bit in the second binary string is 0 or 1. The second device may determine the second label strings and/or fourth label strings used for XOR computation based on the values of the bits in the second binary string. Specifically, the second device may select the second label strings and/or fourth label strings corresponding to the values of the bits in the second binary string, and obtain the second result string by using the XOR algorithm based on the selected second label strings and/or fourth label strings.

If the value of a bit in the second binary string is 0, the second label string corresponding to the bit is selected; and if the value of a bit in the second binary string is 1, the fourth label string corresponding to the bit is selected. The XOR algorithm is performed on the selected second label strings and/or fourth label strings to obtain the second result string. For example, N=2. Corresponding to the four bits of the second binary string, the second label strings are b0_0, b1_0, b2_0, and b3_0, and the fourth label strings are b0_1, b1_1, b2_1, and b3_1. If the second binary string is 1001, the value of the first bit is 1, the fourth label string b0_1 is selected, the value of the second bit is 0, the second label string b1_0 is selected, the value of the third bit is 0, the second label string b2_0 is selected, the value of the fourth bit is 1, the fourth label string b3_1 is selected, and the second result string is z_b =b0_1 ⊕ b1_0 ⊕ b2_0 ⊕ b3_1.

In some embodiments, when the first service parameter is unequal to the second service parameter, a magnitude relationship between the first service parameter and the second service parameter further needs to be determined. The first device and the second device may compare the first binary string and the second binary string by halving. The halving comparison here refers to separately segmenting the first binary string and the second binary string into a high-order string and a low-order string with equal quantity of bits, comparing the high-order string of the first binary string and the high-order string of the second binary string, and comparing the low-order string of the first binary string and the low-order string of the second binary string. The comparison between the high-order strings and the comparison between the low-order strings may follow the comparison whether the first service parameter is equal to the second service parameter in the foregoing embodiments. In at least one case where the high-order strings are unequal or the low-order strings are unequal, the unequal high-order strings and/or low-order strings may be further compared by halving until the quantity of bits of the segmented new high-order string and low-order string is 1, and the magnitude relationship between the first service parameter and the second service parameter may be determined through the values of the bits.

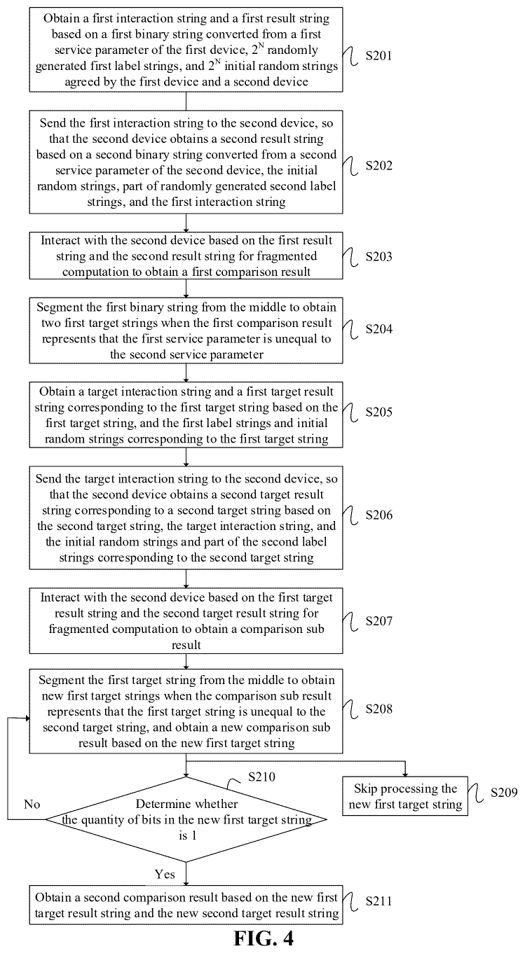

FIG. 4 is a flowchart of a method for comparing service parameters according to still another embodiment in the first aspect of the present application. FIG. 4 differs from FIG. 2 in that the method for comparing service parameters may further include steps S204 to S211.

In step S204, the first binary string is segmented from the middle to obtain two first target strings when the first comparison result represents that the first service parameter is unequal to the second service parameter.

The first target strings include a high-order string and a low-order string, that is, one of the two first target strings is a high-order string and the other one is a low-order string. The high-order string is located at a relatively high order of the segmented string, while the low-order string is located at a relatively low order of the segmented string. For example, the first target string is 01101010. The quantity of bits in the first target string is 8, where the bits from left to right, i.e., from high to low, are the first to eighth bits, 0110 corresponding to the first to fourth bits is a high-order string, and 1010 corresponding to the fifth to eighth bits is a low-order string.

In step S205, a target interaction string and a first target result string corresponding to the first target string are obtained based on the first target string, and the first label strings and initial random strings corresponding to the first target string.

The first device may perform step S205 for the high-order string and the low-order string separately. The first device may obtain a target interaction string and a first target result string corresponding to the high-order string based on the high-order string, the first label strings corresponding to the high-order string, and the initial random strings corresponding to the high-order string. The first device may obtain a target interaction string and a first target result string corresponding to the low-order string based on the low-order string, the first label strings corresponding to the low-order string, and the initial random strings corresponding to the low-order string.

The target interaction string may be obtained based on the first label strings corresponding to the first target string. The target interaction string may be provided to the second device, so that the second device obtains a second target result string based on the target interaction string and information generated by the second device. The first device may establish an association with the second device by using the target interaction string. It should be noted that the first target string cannot be deduced from the target interaction string.

The first target result string may be obtained based on the first target string, the first label strings corresponding to the first target string, and the initial random strings corresponding to the first target string. The first target result string may represent the first target string, but the first target string cannot be reversely deduced from the first target result string. The first target result string may be used for fragmented computation with the second result string generated by the second device to determine whether the first target string is equal to a second target string in the second device.

The computation in step S205 is similar to the computations in step S201 and steps S2011 to S2013 in the foregoing embodiments, and may be referenced to the relevant contents in the foregoing embodiments. The target interaction string may be obtained by using an XOR algorithm based on the first label strings corresponding to the first target string; third label strings corresponding to the first target string are obtained by using the XOR algorithm based on the first label strings corresponding to the first target string and the initial random strings corresponding to the first target string; and the first target result string is obtained based on the first label strings corresponding to the first target string, the third label strings corresponding to the first target string, and the first target string. The third label strings corresponding to the first target string here may be directly obtained from the third label strings computed in step S2012.

For example, N=2, and the quantity of bits in the first target string is 2. If the 4 first label strings in the first device are a0_0, a1_0, a2_0, and a3_0, and the initial random strings are r0, r1, r2, and r3, then the first label strings corresponding to the high-order string include a0_0 and a1_0, the target interaction string corresponding to the high-order string is a_01=a0_0 ⊕ a1_0, the initial random strings corresponding to the high-order string are r0 and r1, and the third label strings corresponding to the high-order string are a0_1 and a1_1, where a0_1=a0_0 ⊕ r0, and a1_1=a1_0 ⊕ r1; the first label strings corresponding to the low-order string include a2_0 and a3_0, the target interaction string corresponding to the low-order string is a_02=a2_0 ⊕a3_0, the initial random strings corresponding to the low-order string are r2 and r3, and the third label strings corresponding to the low-order string are a2_1 and a3_1, where a2_1=a2_0 ⊕ r2, and a3_1=a_0 ⊕ r3. If the value of a bit in the first target string is 0, the first label string corresponding to the bit is selected; if the value of a bit in the first target string is 1, the third label string corresponding to the bit is selected; and the XOR algorithm is performed on the selected first label strings and/or third label strings to obtain the first target result string. If the high-order string is 01, the first target result string corresponding to the high-order string is z_a1=a0_0 ⊕ a1_1; and if the low-order string is 10, the first target result string corresponding to the low-order string is z_a2=a2_1 ⊕ a3_0.

In step S206, the target interaction string is sent to the second device, so that the second device obtains a second target result string corresponding to a second target string based on the second target string, the target interaction string, and the initial random strings and part of the second label strings corresponding to the second target string.

The second target strings include a high-order string and a low-order string obtained by segmenting the second binary string from the middle, that is, one second target string is a high-order string, and the other second target string is a low-order string. The specific contents of the high-order string and the low-order string may be referenced to the relevant explanations in the foregoing embodiments, and will not be repeated here.

The second device may obtain the second target result string corresponding to the second target string based on the second target string, the target interaction string, and the initial random strings and part of the second label strings corresponding to the second target string. The second device obtains a second target result string corresponding to the high-order string based on the high-order string segmented from the second binary string, the second label strings corresponding to the high-order string, and the initial random strings corresponding to the high-order string. The second device obtains a second target result string corresponding to the low-order string based on the low-order string segmented from the second binary string, the target interaction string, the second label strings corresponding to the low-order string, and the initial random strings corresponding to the low-order string.

The second target result string may be obtained based on the second target string, the target interaction string, the second label strings corresponding to the second target string, and the initial random strings corresponding to the second target string. The second target result string may represent the second target string, but the second target string cannot be reversely deduced from the second target result string. The second target result string may be used for fragmented computation with the first result string generated by the first device to determine whether the second target string is equal to the first target string in the first device.

In step S207, the first device interacts with the second device based on the first target result string and the second target result string for fragmented computation to obtain a comparison sub-result.

The specific content of fragmented computation may be referenced to the relevant content in the foregoing embodiment, and will not be repeated here. The comparison sub-result may represent whether the first target string is equal to the second target string.

In step S208, the first target string is segmented from the middle to obtain new first target strings when the comparison sub-result represents that the first target string is unequal to the second target string, and obtain a new comparison sub-result based on the new first target string.

The new first target strings may include a high-order string and a low-order string obtained by segmenting the original first target string from the middle. The step of obtaining a new comparison sub-result based on the new first target string may include: obtaining a new target interaction string and a new first target result string corresponding to the new first target string based on the new first target string, and the first label strings and initial random strings corresponding to the new first target string; sending the new target interaction string to the second device, so that the second device obtains a new second target result string corresponding to a new second target string based on the new second target string, the new target interaction string, and the initial random strings and part of the second label strings corresponding to the new second target string; and interacting with the second device based on the new first target result string and the new second target result string for fragmented computation to obtain the new comparison sub-result.

The above steps may be repeated until the new comparison sub-result represents that the new first target string is equal to the new second target string, or until the new first target string is a binary number and the second comparison result is obtained. The second comparison result may represent a magnitude relationship between the first service parameter and the second service parameter. The second comparison result represents that the first service parameter is greater than the second service parameter or the first service parameter is less than the second service parameter.

That is, if the new comparison sub-result represents that the new first target string is equal to the new second target string, step S209 is performed; or if the new comparison sub-result represents that the new first target string is unequal to the new second target string, step S210 is performed.

In step S209, processing the new first target string is skipped. Correspondingly, the second device also does not process the new second target string.

If the new first target string is equal to the new second target string, further comparison is unnecessary. Therefore, further processing of the new first target string and the new second target string is not required.

In step S210, it is determined whether the quantity of bits in the new first target string is 1.

The quantity of bits in the new first target string is equal to the quantity of bits in the new second target string. If the new first target string is unequal to the new second target string, further comparison is required to determine a magnitude relationship between the new first target string and the new second target string, so as to determine the magnitude relationship between the first service parameter and the second service parameter. If the quantity of bits in both the new first target string and the new second target string is 1, the second comparison result may be directly obtained. If the quantity of bits in both the new first target string and the new second target string is not 1, further halving comparison is required, and the above step of obtaining a new first target result string and a new second target result string is repeated.

That is, if the quantity of bits in both the new first target string and the new second target string is 1, step S211 is performed; if the quantity of bits in both the new first target string and the new second target string is not 1, step S208 is performed again: segmenting the first target string from the middle to obtain new first target strings, and obtaining a new comparison sub-result based on the new first target string.

In step S211, a second comparison result is obtained based on the new first target result string and the new second target result string.

When the quantity of bits in both the new first target string and the new second target string is 1, and the new first target string is unequal to the new second target string, one of the new first target string and the new second target string is definitely 0, and the other one is 1. If 1>0, the second comparison result may be obtained.

In some examples, when the new second target string is a binary number, the second label string corresponding to the new second target string is updated by the second device based on the original second label string corresponding to the new second target string and the new target interaction string, and the fourth label string corresponding to the new second target string is obtained by the second device based on the updated second label string and initial random string corresponding to the new second target string.

For example, N=2, the third bit of the second binary string is a new second target string, and the updated second label string corresponding to the new second target string is b2_0=2_0⊕ a_0 ⊕ b2_0, where b2_0 on the left of the equal sign represents the updated second label string corresponding to the new second target string, b2_0 on the right of the equal sign represents the original second label string corresponding to the new second target string, and a_0 on the right of the equal sign represents the new target interaction string; correspondingly, the fourth label string corresponding to the new second target string is b2_1=b2_0 ⊕ r2, where b2_0 on the right of the equal sign represents the updated second label string corresponding to the new second target string, and r2 on the right of the equal sign represents the initial random string corresponding to the new second target string.

In the foregoing embodiment, when the magnitude relationship between the first service parameter and the second service parameter needs to be obtained, a halving comparison method may be used for gradual determination. The computations associated with the first target string and the second target string obtained by halving each time may be executed in parallel, thereby shortening the computation time and further improving the efficiency of service parameter comparison.

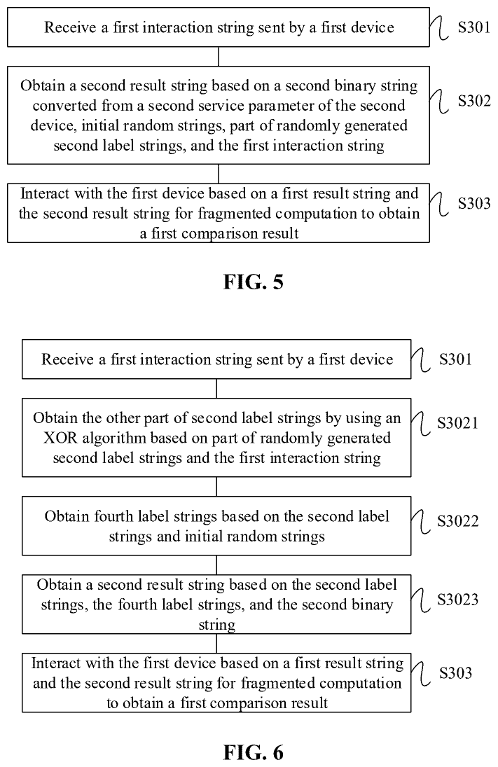

A second aspect of the present application provides a method for comparing service parameters, which may be applied to a second device, that is, the method for comparing service parameters may be executed by the second device. FIG. 5 is a flowchart of a method for comparing service parameters according to an embodiment in a second aspect of the present application. As shown in FIG. 5, the method for comparing service parameters may include steps S301 to S303.

In step S301, a first interaction string sent by a first device is received.

The first interaction string is obtained by the first device based on N randomly generated first label strings.

In step S302, a second result string is obtained based on a second binary string converted from a second service parameter of the second device, initial random strings, part of randomly generated second label strings, and the first interaction string.

The second binary string includes 2^{N} bits, where N is a positive integer.

In step S303, the first device interacts with the first device based on a first result string and the second result string for fragmented computation to obtain a first comparison result.

The first result string is obtained by the first device based on a first binary string converted from a first service parameter of the first device, the first label strings, and N initial random strings agreed by the first device and the second device. The first comparison result represents whether the first service parameter is equal to the second service parameter. The first binary string includes 2^{N} bits.

In some examples, N≥4.

The specific contents of steps S301 to S303 may be referenced to the relevant explanations in the foregoing embodiments, and will not be repeated here.

In the embodiment of the present application, the first device computes the first interaction string and the first result string locally based on the first binary string converted from the first service parameter thereof, the first label strings, and the initial random strings, and the first device sends the first interaction string to the second device. The second device computes the second result string locally based on the second binary string converted from the second service parameter thereof, the second label strings, the initial random strings, and the first interaction string. The first device interacts with the second device based on the first result string and the second result string for fragmented computation to obtain the first comparison result indicating whether the first service parameter is equal to the second service parameter. Most of the computations in the entire process are performed locally in both the first device and the second device, and there is merely a very small amount of communication interaction between the first device and the second device during the transmission of the first interaction string and the fragmented computation, thereby reducing communication interactions between the first device and the second device and improving the efficiency of multi-party service parameter comparison. Moreover, plaintexts of the first service parameter in the first device and the second service parameter in the second device terminal will not be leaked, thereby ensuring privacy security and making the method very suitable for scenarios such as federated learning and secure handover.

FIG. 6 is a flowchart of a method for comparing service parameters according to another embodiment in the second aspect of the present application. FIG. 6 differs from FIG. 5 in that step S302 in FIG. 5 may be specifically refined into steps S3021 to S3023 in FIG. 6.

In step S3021, the other part of second label strings are obtained by using an XOR algorithm based on part of randomly generated second label strings and the first interaction string.

In step S3022, fourth label strings are obtained based on the second label strings and initial random strings.

The second label strings represent that values of the corresponding bits in the second binary string are 0. The fourth label strings represent that values of the corresponding bits in the second binary string are 1.

In step S3023, a second result string is obtained based on the second label strings, the fourth label strings, and the second binary string.

In some examples, the second device may select the second label strings and/or fourth label strings corresponding to the values of the bits in the second binary string, and obtain the second result string by using the XOR algorithm based on the selected second label strings and/or fourth label strings.

The specific contents of steps S3021 to S3023 may be referenced to the relevant explanations in the foregoing embodiments, and will not be repeated here.

In some embodiments, the first result string is obtained by the first device based on the first label strings, the third label strings, and the first binary string. The first label strings represents that values of the corresponding bits in the first binary string are 0. The third label strings represent that values of the corresponding bits in the first binary string are 1. The third label strings are obtained by the first device using the XOR algorithm based on the first label strings and the initial random strings.

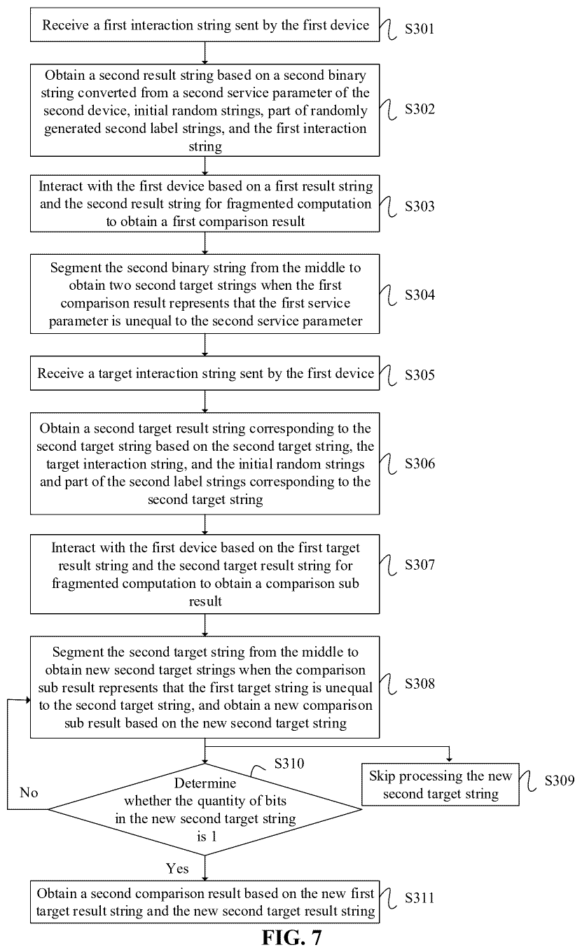

FIG. 7 is a flowchart of a method for comparing service parameters according to still another embodiment in the second aspect of the present application. FIG. 7 differs from FIG. 5 in that the method for comparing service parameters in FIG. 7 may further include steps S304 to S311.

In step S304, the second binary string is segmented from the middle to obtain two second target strings when the first comparison result represents that the first service parameter is unequal to the second service parameter.

The second target strings include a high-order string and a low-order string.

In step S305, a target interaction string sent by the first device is received.

The target interaction string is obtained by the first device based on a first target string, and the first label strings and initial random strings corresponding to the first target string. The first target strings include a high-order string and a low-order string obtained by segmenting the first binary string from the middle.

In step S306, a second target result string corresponding to the second target string is obtained based on the second target string, the target interaction string, and the initial random strings and part of the second label strings corresponding to the second target string.

In step S307, the second device interacts with the first device based on the first target result string and the second target result string for fragmented computation to obtain a comparison sub-result.

The comparison sub-result represents whether the first target string is equal to the second target string.

In step S308, the second target string is segmented from the middle to obtain new second target strings when the comparison sub-result represents that the first target string is unequal to the second target string, and obtain a new comparison sub-result based on the new second target string.

The new second target strings may include a high-order string and a low-order string obtained by segmenting the original second target string from the middle. The step of obtaining a new comparison sub-result based on the new second target string may include: obtaining a new second target result string corresponding to the new second target string based on the new second target string, the new target interaction string, and the second label strings and initial random strings corresponding to the new second target string; and interacting with the first device based on the new first target result string and the new second target result string for fragmented computation to obtain the new comparison sub-result.

The above steps may be repeated until the new comparison sub-result represents that the new first target string is equal to the new second target string, or until the new second target string is a binary number and a second comparison result is obtained. The second comparison result represents that the first service parameter is greater than the second service parameter or the first service parameter is less than the second service parameter.

That is, if the new comparison sub-result represents that the new first target string is equal to the new second target string, step S309 is performed; or if the new comparison sub-result represents that the new first target string is unequal to the new second target string, step S310 is performed.

In step S309, processing the new second target string is skipped. Correspondingly, the first device also does not process the new first target string.

In step S310, it is determined whether the quantity of bits in the new second target string is 1.

The quantity of bits in the new second target string is equal to the quantity of bits in the new first target string. If the new first target string is unequal to the new second target string, further comparison is required to determine a magnitude relationship between the new first target string and the new second target string, so as to determine the magnitude relationship between the first service parameter and the second service parameter. If the quantity of bits in both the new first target string and the new second target string is 1, the second comparison result may be directly obtained. If the quantity of bits in both the new first target string and the new second target string is not 1, further halving comparison is required, and the above step of obtaining a new first target result string and a new second target result string is repeated.

That is, if the quantity of bits in both the new first target string and the new second target string is 1, step S311 is performed; if the quantity of bits in both the new first target string and the new second target string is not 1, step S308 is performed again: segmenting the second target string from the middle to obtain new second target strings, and obtaining a new comparison sub-result based on the new second target string.

In step S311, a second comparison result is obtained based on the new first target result string and the new second target result string.

In some examples, when the new second target string is a binary number, the second device may obtain an updated second label string corresponding to the new second target string based on the original second label string corresponding to the new second target string and the new target interaction string; and obtain the fourth label string corresponding to the new second target string based on the updated second label string and initial random string corresponding to the new second target string. The specific content may be referenced to the relevant explanations in the foregoing embodiments, and will not be repeated here.

The specific contents of steps S304 to S311 may be referenced to the relevant explanations in the foregoing embodiments, and will not be repeated here.

For ease of understanding, two specific examples are provided below to illustrate the process of comparing service parameters.

An example where the first service parameter is equal to the second service parameter is first taken to illustrate the process of comparing service parameters. It is assumed that the first service parameter is 9, the second service parameter is 9, the quantity of bits in the first binary string converted from the first service parameter and the quantity of bits in the second binary string converted from the second service parameter are both 4, and the first binary string and the second binary string are both 1001. The process of comparing service parameters may include steps c1 to c11.

In step c1, the first device and the second device obtain a random number seed through the DH algorithm, and the first device and the second device each use the random number seed to randomly generate initial random strings r0, r1, r2, and r3. R0 corresponds to the first bit of the first binary string, r1 corresponds to the second bit of the first binary string, r2 corresponds to the third bit of the first binary string, and r3 corresponds to the fourth bit of the first binary string. r0=1111, r1=1101, r2=1100, and r3=1010.

In step c2, the first device randomly generates 4 first label strings a0_0, a1_0, a2_0, and a3_0. a0_0 corresponds to the first bit of the first binary string, a1_0 corresponds to the second bit of the first binary string, a2_0 corresponds to the third bit of the first binary string, and a3_0corresponds to the fourth bit of the first binary string. a0_0=0001, a1_0=1001, a2_0=1110, and a3_0=1001.

In step c3, the first device performs XOR computation on the first label strings and initial random strings corresponding to the same bits to obtain 4 third label strings a0_1, a1_1, a2_1, and a3_1. a0_1 corresponds to the first bit of the first binary string, a1_1 corresponds to the second bit of the first binary string, a2_1 corresponds to the third bit of the first binary string, and a3_1 corresponds to the fourth bit of the first binary string. a0_1=a0_0 ⊕ r0=1110, a1_1=a1_0 ⊕ r1=0100, a2_1=⊕ r2-0010, and a3_1=a3_0 ⊕ r3=0011.

In step c4, the first device performs XOR computation on the 4 first label strings a0_0, a1_0, a2_0, and a3_0 to obtain a first interaction string a_0. a_0=a0_0 ⊕ a1_0 ⊕ a2_0 ⊕ a3_0=1111.

In step c5, the first device sends the first interaction string a_0 to the second device.

In step c6, the second device randomly generates 3 second label strings b0_0, b1_0, and b2_0. b0_0 corresponds to the first bit of the second binary string, b1_0 corresponds to the second bit of the second binary string, and b2_0 corresponds to the third bit of the second binary string. b0_0=1011, b1_0=0011, and b2_0=1010.

In step c7, the second device performs XOR computation on the second label strings b0_0, b1_0, and b2_0 and the first interaction string a_0 to obtain a 4^{th} second label string b3_0. b3_0=b0_0 ⊕ b1_0⊕ b2_0 ⊕ a_0=1101.

In step c8, the second device performs XOR computation on the second label strings and initial random strings corresponding to the same bits to obtain 4fourth label strings b0_1, b1_1, b2_1, and b3_1. b0_1 corresponds to the first bit of the second binary string, b1_1 corresponds to the second bit of the second binary string, b2_1 corresponds to the third bit of the second binary string, and b3_1 corresponds to the fourth bit of the second binary string. b0_1=b0_0⊕ r0=0100, b1_1=b1_0 ⊕ r1=1110, b2_1=b2_0 ⊕ r2=0110, and b3_1=b3_0 ⊕ r3=0111.

In step c9, the first device selects the third label string a0_1, the first label string a1_0, the first label string a2_0, and the third label string a3_1 based on the first binary string 1001, and performs XOR computation on the selected first label strings and third label strings to obtain a first result string z_a. z_a=a0_1 ⊕ a1_0 ⊕ a2_0 ⊕ a3_1 =1010.

In step c10, the second device selects the fourth label string b0_1, the second label string b1_0, the second label string b2_0, and the fourth label string b3_1 based on the second binary string 1001, and performs XOR computation on the selected second label strings and fourth label strings to obtain a second result string z_b. z_b=b0_1 ⊕ b1_0 ⊕ b2_0 ⊕ b3_132 1010.

In step c11, the first device interacts with the second device based on the first result string and the second result string for fragmented computation to obtain a first comparison result, where the first comparison result represents that the first service parameter is equal to the second service parameter.

An example where the first service parameter is unequal to the second service parameter is then taken to illustrate the process of comparing service parameters. It is assumed that the first service parameter is 9, the second service parameter is 9, the quantity of bits in the first binary string converted from the first service parameter and the quantity of bits in the second binary string converted from the second service parameter are both 4, the first binary string is 1000, and the second binary string is 1001. The process of comparing service parameters may include steps d1 to d34.

In step d1, the first device and the second device obtain a random number seed through the DH algorithm, and the first device and the second device each use the random number seed to randomly generate initial random strings r0, r1, r2, and r3. r0 corresponds to the first bit of the first binary string, r1 corresponds to the second bit of the first binary string, r2 corresponds to the third bit of the first binary string, and r3 corresponds to the fourth bit of the first binary string. r0=1111, r1=1101, r2=1100, and r3=1010.

In step d2, the first device randomly generates 4 first label strings a0_0, a1_0, a2_0, and a3_0. a0_0 corresponds to the first bit of the first binary string, a1_0 corresponds to the second bit of the first binary string, a2_0 corresponds to the third bit of the first binary string, and a3_0 corresponds to the fourth bit of the first binary string. a0_0=0001, a1_0=1001, a2_0=1110, and a3_0=1001.

In step d3, the first device performs XOR computation on the first label strings and initial random strings corresponding to the same bits to obtain 4 third label strings a0_1, a1_1, a2_1, and a3_1. a0_1 corresponds to the first bit of the first binary string, a1_1 corresponds to the second bit of the first binary string, a2_1 corresponds to the third bit of the first binary string, and a3_1 corresponds to the fourth bit of the first binary string. a0_1=a0_0 ⊕ r0=1110, a1_1=a1_0 ⊕ r1=0100, a2_1=a2_0 ⊕ r2=0010, and a3_1=a3_0 61 r3=0011.

In step d4, the first device performs XOR computation on the 4 first label strings a0_0, a1_0, a2_0, and a3_0 to obtain a first interaction string a_0. a_0 =a0_0 ⊕ a1_0 ⊕ a2_0 ⊕ a3_0=1111.

In step d5, the first device sends the first interaction string a 0 to the second device.

In step d6, the second device randomly generates 3 second label strings b0_0, b1_0, and b2_0. b0_0 corresponds to the first bit of the second binary string, b1_0 corresponds to the second bit of the second binary string, and b2_0 corresponds to the third bit of the second binary string. b0_0=1011, b1_0=0011, and b2_0=1010.

In step d7, the second device performs XOR computation on the second label strings b0_0, b1_0, and b2_0 and the first interaction string a_0 to obtain a 4^{th} second label string b3_0. b3_0=b0_0 ⊕ b1_0 ⊕ b2_0 a_032 1101.

In step d8, the second device performs XOR computation on the second label strings and initial random strings corresponding to the same bits to obtain 4 fourth label strings b0_1, b1_1, b2_1, and b3_1. b0_1 corresponds to the first bit of the second binary string, b1_1 corresponds to the second bit of the second binary string, b2_1 corresponds to the third bit of the second binary string, and b3_1 corresponds to the fourth bit of the second binary string. b0_1=b0_0 ⊕ r0=0100, b1_1=b1_0 ⊕ r1=1110, b2_1=b2_0 ⊕ r2=0110, and b3_1=b3_0 ⊕ r3=0111.

In step d9, the first device selects the third label string a0_1, the first label string a1_0, the first label string a2_0, and the first label string a3_0 based on the first binary string 1000, and performs XOR computation on the selected first label strings and third label string to obtain a first result string z_a. z_a=a0_1 ⊕ a1_0 ⊕ a2_0 ⊕ a3_0=0111.

In step d10, the second device selects the fourth label string b0_1, the second label string b1_0, the second label string b2_0, and the fourth label string b3_1 based on the second binary string 1001, and performs XOR computation on the selected second label strings and fourth label strings to obtain a second result string z_b. z_b=b0_1 ⊕ b1_0 ⊕ b2_0 ⊕ b3_1=1010.

In step d11, the first device interacts with the second device based on the first result string and the second result string for fragmented computation to obtain a first comparison result, where the first comparison result represents that the first service parameter is unequal to the second service parameter.

In step d12, the first device segments the first binary string 1000 into a high-order string 10 and a low-order string 00.

In step d13, the first device obtains a first target result string z_a1=a0_1 ⊕ a1_0=0111 corresponding to the high-order string 10 based on the third label string a0_1 and first label string a1_0 corresponding to the high-order string 10.

In step d14, the first device obtains a target interaction string a_01 corresponding to the high-order string 10 based on the first label strings a0_0 and a1_0 corresponding to the high-order string 10. a_01=a0_0 ⊕ a1_0=1000.

In step d15, the first device sends the target interaction string a_01 corresponding to the high-order string to the second device.

In step d16, the second device segments the second binary string 1001 into a high-order string 10 and a low-order string 01.

In step d17, the second device obtains the second label string b1_0 corresponding to the second bit in the second binary string based on the second label string b0_0 corresponding to the first bit in the second binary string and the received target interaction string a_01. b1_0=b0_0 ⊕ a01=0011.

In step d18, the second device may obtain the corresponding fourth label strings b0_1 and b1_1 based on the second label strings b0_0 and b1_0 and the initial random strings r0 and r1. b0_1=b0_0 ⊕ r0=0100, b1_1=b1_0 ⊕ r1=1110.

In step d19, the second device obtains a second target result string z_b1=b0_1 ⊕ b1_0=0111 corresponding to the high-order string 10 based on the fourth label string b0_1 and second label string b1_0 corresponding to the high-order string 10.

In step d20, the first device interacts with the second device based on the first target result string z_a1 and the second target result string z_b1 for fragmented computation to obtain a comparison sub-result, where the comparison sub-result represents that the high-order string 10 of the first binary string is equal to the high-order string 10 of the second binary string.

In step d21, the first device may repeat computations similar to those in steps d13 to d15 for the low-order string 00 to obtain a first target result string z_a2; and the second device may repeat computations similar to those in steps d17 to d19 for the low-order string 01 to obtain a second target result string z_b2.

In step d22, the first device interacts with the second device based on the first target result string z_a1 and the second target result string z_b1 for fragmented computation to obtain a comparison sub-result, where the comparison sub-result represents that the low-order string 00 of the first binary string is unequal to the low-order string 01 of the second binary string.

In step d23, the first device segments the unequal low-order string 00 into a new high-order string 0 and a new low-order string 0, where the new high-order string 0 is the third bit of the first binary string, and the new low-order string 0 is the fourth bit of the first binary string.

In step d24, the first device obtains a new target interaction string a_021 based on the first label string a2_0 corresponding to the third bit of the first binary number. a_021=a2_0=1110.

In step d25, the first device obtains the third label string a2_1 based on the first label string a2_0 and the initial random string r2. a2_1=a2_0 ⊕ r2=0010.

In step d26, the first device obtains a new first target result string z_a21 based on the first label string a2_0 corresponding to the new high-order string 0. z_a21=a2_0=1110.

In step d27, the first device sends the new target interaction string a_021 to the second device.

In step d28, the second device segments the unequal low-order string 01 into a new high-order string 0 and a new low-order string 1, where the new high-order string 0 is the third bit of the second binary string, and the new low-order string 1 is the fourth bit of the second binary string.

In step d29, the second device updates the second label string b2_0 based on the new target interaction string a_021 and the original second label string b2_0. The original second label string is b2_0=1010, and the updated second label string is b2_0=b2_0 ⊕ a_021 ⊕ b2_0=1110.

In step d30, the second device obtains the fourth label string b2_1=b2_0 ⊕ r2=0010 based on the updated second label string b2_0 and the initial random string r2.

In step d31, the second device obtains a new first target result string z_b21 based on the second label string b2_0 corresponding to the new high-order string 0. z_b21=b2_0=1110.

In step d32, the first device interacts with the second device based on the first target result string z_a21 and the second target result string z_b21 for fragmented computation to obtain a comparison sub-result, where the comparison sub-result represents that the value 0 of the third bit in the first binary string is equal to the value 0 of the third bit in the second binary string.

In step d33, the first device may repeat computations similar to those in steps d24 to d27 for the new low-order string 0 (i.e. the value of the fourth bit in the first binary string) to obtain a first target result string z_a22; and the second device may repeat computations similar to those in steps d29 to step d32 for the new low-order string 1 (i.e. the value of the fourth bit in the second binary string) to obtain a second target result string z_b22.

In step d34, the first device interacts with the second device based on the first target result string z_a21 and the second target result string z_b21 for fragmented computation to obtain a second comparison result. The second comparison result represents that the first service parameter is less than the second service parameter.

The method for comparing service parameters in the embodiments of the present application may be applied to various scenarios that require service parameter comparison. Details will not be elaborated here.

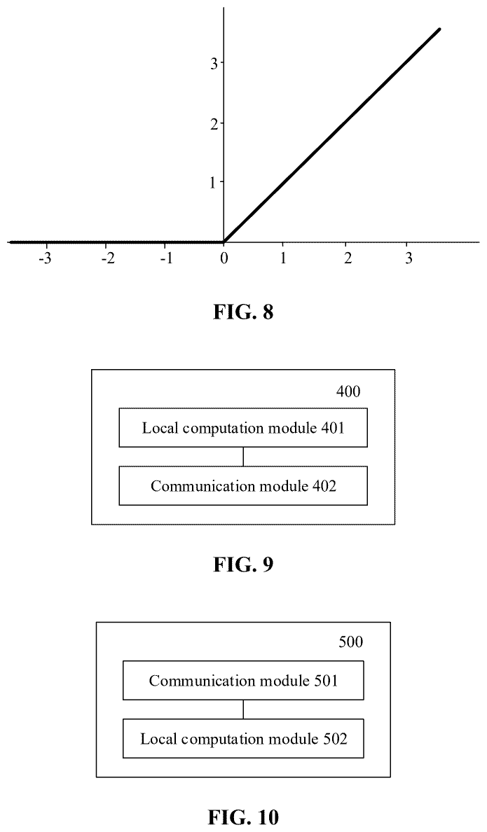

In some examples, in a scenario where a neural network is used to train a service model, a rectified linear unit (ReLu) f(x)=max(0, wx+b) may be used as an activation function for a neuron in the neural network to define a non-linear output result of the neuron after linear transformation wx+b. For an input vector that enters the neuron and comes from the previous level of the neural network, the neuron using the activation function will output max (0, wx+b). The rectified linear unit has sparsity, which enables the sparse model to better mine relevant features and fit training data. FIG. 8 is a schematic curve diagram of an example of a rectified linear unit according to an embodiment of the present application. In a region of x>0 in FIG. 8, gradient saturation or gradient vanishing will not occur, the computational complexity is low, no exponential operation is required, and an activation value may be obtained with only one threshold. The selection of the rectified linear unit as the activation function in a hidden layer of the neural network can ensure that the gradient is always 1 when z is greater than zero, thereby improving the computational speed of a gradient descent algorithm for the neural network. Variant functions derived from the rectified linear unit, such as a parametric rectified linear unit (Prelu) and a leaky ReLU (Lrelu), may also be used as activation functions for neurons. In the activation function formula, 0 and wx+b need to be compared to obtain a magnitude relationship between 0 and wx+b. In the comparison process, wx+b leakage needs to be prevented.

In some examples, service processing requires usage of a sigmoid function or the like and comparison of service parameters. Alternatively, service processing requires comparison to distinguish boundaries of a segmented function. Alternatively, in a private set intersection (PSI) link of a deep learning scenario, dense determination of an intersection and comparison of some service parameters are required.

A third aspect of the present application provides a first device. FIG. 9 is a schematic structural diagram of a first device according to an embodiment in the third aspect of the present application. As shown in FIG. 9, the first device 400 includes a local computation module 401 and a communication module 402.

The local computation module 401 may be configured to obtain a first interaction string and a first result string based on a first binary string converted from a first service parameter of the first device, 2^{N} randomly generated first label strings, and 2^{N} initial random strings agreed by the first device and a second device. The first binary string includes 2^{N} bits, where N is a positive integer.

The communication module 402 is configured to send the first interaction string to the second device, so that the second device obtains a second result string based on a second binary string converted from a second service parameter of the second device, the initial random strings, part of randomly generated second label strings, and the first interaction string. The second binary string includes 2^{N} bits.

The communication module 402 and the local computation module 401 are further configured to interact with the second device based on the first result string and the second result string for fragmented computation to obtain a first comparison result.

The first comparison result represents whether the first service parameter is equal to the second service parameter.

In some examples, N≥4.

In the embodiment of the present application, the first device computes the first interaction string and the first result string locally based on the first binary string converted from the first service parameter thereof, the first label strings, and the initial random strings, and the first device sends the first interaction string to the second device. The second device computes the second result string locally based on the second binary string converted from the second service parameter thereof, the second label strings, the initial random strings, and the first interaction string. The first device interacts with the second device based on the first result string and the second result string for fragmented computation to obtain the first comparison result indicating whether the first service parameter is equal to the second service parameter. Most of the computations in the entire process are performed locally in both the first device and the second device, and there is merely a very small amount of communication interaction between the first device and the second device during the transmission of the first interaction string and the fragmented computation, thereby reducing communication interactions between the first device and the second device and improving the efficiency of multi-party service parameter comparison. Moreover, plaintexts of the first service parameter in the first device and the second service parameter in the second device terminal will not be leaked, thereby ensuring privacy security and making the method very suitable for scenarios such as federated learning and secure handover.

In some embodiments, the local computation module 401 is configured to: obtain the first interaction string by using an XOR algorithm based on the first label strings; obtain 2^{N} third label strings by using the XOR algorithm based on the first label strings and the initial random strings, where the first label strings represent that values of the corresponding bits in the first binary string are 0, and the third label strings represent that values of the corresponding bits in the first binary string are 1; and obtain the first result string based on the first label strings, the third label strings, and the first binary string.

In some examples, the local computation module 401 is configured to: select the first label strings and/or third label strings corresponding to the values of the bits in the first binary string, and obtain the first result string by using the XOR algorithm based on the selected first label strings and/or third label strings.

In some embodiments, the second result string is obtained by the second device based on the second label strings, fourth label strings, and the second binary string. The second label strings represent that values of the corresponding bits in the second binary string are 0, and part of the second label strings are obtained by using the XOR algorithm based on the other part of the randomly generated second label strings and the first interaction string. The fourth label strings represent that values of the corresponding bits in the second binary string are 1, and the fourth label strings are obtained by the second device using the XOR algorithm based on the second label strings and the initial random strings.

In some embodiments, the local computation module 401 may be further configured to: segment the first binary string from the middle to obtain two first target strings when the first comparison result represents that the first service parameter is unequal to the second service parameter, where the first target strings include a high-order string and a low-order string; and obtain a target interaction string and a first target result string corresponding to the first target string based on the first target string, and the first label strings and initial random strings corresponding to the first target string.

The communication module 402 may be further configured to: send the target interaction string to the second device, so that the second device obtains a second target result string corresponding to a second target string based on the second target string, the target interaction string, and the initial random strings and part of the second label strings corresponding to the second target string. The second target strings include a high-order string and a low-order string obtained by segmenting the second binary string from the middle.

The local computation module 401 and communication module 402 may be further configured to: interact with the second device based on the first target result string and the second target result string for fragmented computation to obtain a comparison sub-result, where the comparison sub-result represents whether the first target string is equal to the second target string.

The local computation module 401 and the communication module 402 may be further configured to: segment the first target string from the middle to obtain new first target strings when the comparison sub-result represents that the first target string is unequal to the second target string, and obtain a new comparison sub-result based on the new first target string until the new comparison sub-result represents that the new first target string is equal to the new second target string, or until the new first target string is a binary number and the second comparison result is obtained, where the second comparison result represents that the first service parameter is greater than the second service parameter or the first service parameter is less than the second service parameter.

In some embodiments, when the new second target string is a binary number, the second label string corresponding to the new second target string is updated by the second device based on the original second label string corresponding to the new second target string and the new target interaction string. The fourth label string corresponding to the new second target string is obtained by the second device based on the updated second label string and initial random string corresponding to the new second target string.

A fourth aspect of the present application provides a second device. FIG. 10 is a schematic structural diagram of a second device according to an embodiment in the fourth aspect of the present application. As shown in FIG. 10, the second device 500 includes a communication module 501 and a local computation module 502.

The communication module 501 may be configured to receive a first interaction string sent by a first device. The first interaction string is obtained by the first device based on N randomly generated first label strings.

The local computation module 502 may be configured to obtain a second result string based on a second binary string converted from a second service parameter of the second device, initial random strings, part of randomly generated second label strings, and the first interaction string. The second binary string includes 2^{N} bits, where N is a positive integer.

The communication module 501 and the local computation module 502 may be further configured to interact with the first device based on a first result string and the second result string for fragmented computation to obtain a first comparison result. The first result string is obtained by the first device based on a first binary string converted from a first service parameter of the first device, the first label strings, and N initial random strings agreed by the first device and the second device. The first comparison result represents whether the first service parameter is equal to the second service parameter. The first binary string includes 2^{N} bits.

In some examples, N≥4.

In the embodiment of the present application, the first device computes the first interaction string and the first result string locally based on the first binary string converted from the first service parameter thereof, the first label strings, and the initial random strings, and the first device sends the first interaction string to the second device. The second device computes the second result string locally based on the second binary string converted from the second service parameter thereof, the second label strings, the initial random strings, and the first interaction string. The first device interacts with the second device based on the first result string and the second result string for fragmented computation to obtain the first comparison result indicating whether the first service parameter is equal to the second service parameter. Most of the computations in the entire process are performed locally in both the first device and the second device, and there is merely a very small amount of communication interaction between the first device and the second device during the transmission of the first interaction string and the fragmented computation, thereby reducing communication interactions between the first device and the second device and improving the efficiency of multi-party service parameter comparison. Moreover, plaintexts of the first service parameter in the first device and the second service parameter in the second device terminal will not be leaked, thereby ensuring privacy security and making the method very suitable for scenarios such as federated learning and secure handover.

In some embodiments, the local computation module 502 may be configured to: obtain the other part of second label strings by using an XOR algorithm based on the part of randomly generated second label strings and the first interaction string; obtain fourth label strings based on the second label strings and the initial random strings, where the second label strings represent that values of the corresponding bits in the second binary string are 0, and the fourth label strings represent that values of the corresponding bits in the second binary string are 1; and obtain a second result string based on the second label strings, the fourth label strings, and the second binary string.

In some examples, the local computation module 502 may be configured to: select the second label strings and/or fourth label strings corresponding to the values of the bits in the second binary string, and obtain the second result string by using the XOR algorithm based on the selected second label strings and/or fourth label strings.

In some embodiments, the first result string is obtained by the first device based on the first label strings, third label strings, and the first binary string. The first label strings represent that values of the corresponding bits in the first binary string are 0. The third label strings represent that values of the corresponding bits in the first binary string are 1, and the third label strings are obtained by the first device using the XOR algorithm based on the first label strings and the initial random strings.

In some embodiments, the local computation module 502 may be further configured to: segment the second binary string from the middle to obtain two second target strings when the first comparison result represents that the first service parameter is unequal to the second service parameter, where the second target strings include a high-order string and a low-order string.

The communication module 501 may be further configured to receive a target interaction string sent by the first device. The target interaction string is obtained by the first device based on a first target string, and the first label strings and initial random strings corresponding to the first target string. The first target strings include a high-order string and a low-order string obtained by segmenting the first binary string from the middle.

The local computation module 502 may be further configured to: obtain a second target result string corresponding to the second target string based on the second target string, the target interaction string, and the initial random strings and part of the second label strings corresponding to the second target string.

The communication module 501 and the local computation module 502 may be further configured to: interact with the first device based on the first target result string and the second target result string for fragmented computation to obtain a comparison sub-result, where the comparison sub-result represents whether the first target string is equal to the second target string.

The communication module 501 and the local computation module 502 may be further configured to: segment the second target string from the middle to obtain new second target strings when the comparison sub-result represents that the first target string is unequal to the second target string, and obtain a new comparison sub-result based on the new second target string until the new comparison sub-result represents that the new first target string is equal to the new second target string, or until the new second target string is a binary number and a second comparison result is obtained. The second comparison result represents that the first service parameter is greater than the second service parameter or the first service parameter is less than the second service parameter.

In some examples, the local computation module 502 may be further configured to: when the new second target string is a binary number, obtain an updated second label string corresponding to the new second target string based on the original second label string corresponding to the new second target string and the new target interaction string; and obtain the fourth label string corresponding to the new second target string based on the updated second label string and initial random string corresponding to the new second target string.

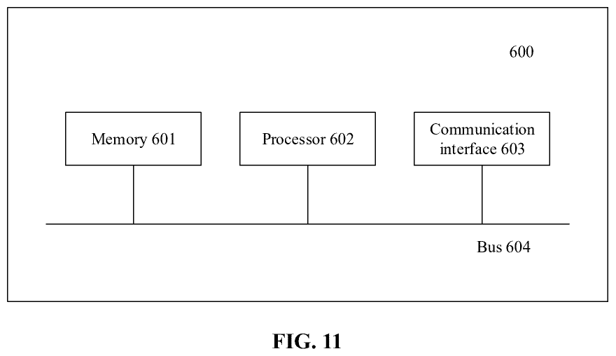

A fifth aspect of the present application further provides an electronic device. FIG. 11 is a schematic structural diagram of an electronic device according to an embodiment in the fifth aspect of the present application. As shown in FIG. 11, the electronic device 600 includes a memory 601, a processor 602, and a computer program stored in the memory 601 and executable on the processor 602.

In some examples, the processor 602 may be a central processing unit (CPU) or an application specific integrated circuit (ASIC), or may be configured to implement one or more integrated circuits in the embodiments of the present application.

The memory 601 may be a read-only memory (ROM), a random access memory (RAM), a magnetic disk storage medium device, an optical storage medium device, a flash memory device, or an electrical, optical, or other physical/tangible memory device. Generally, the memory includes one or more tangible (non-transient) computer-readable storage media (e.g., memory devices) encoded with software including computer executable instructions, and the software, when executed (e.g., by one or more processors), is operable to perform the operations described in the method for comparing service parameters in the embodiments of the first aspect of the present application or the method for comparing service parameters in the embodiments of the second aspect of the present application.

The processor 602 runs a computer program corresponding to executable program code stored in the memory 601 by reading the executable program code to implement the method for comparing service parameters in the embodiments of the first aspect or the method for comparing service parameters in the embodiments of the second aspect.

In some examples, the electronic device 600 may further include a communication interface 603 and a bus 604. As shown in FIG. 11, the memory 601, the processor 602, and the communication interface 603 are connected and communicate with each other through the bus 604.

The communication interface 603 is mainly configured to implement communication between various modules, apparatuses, units, and/or devices in the embodiments of the present application. Input and/or output devices may also be connected through the communication interface 603.

The bus 604 includes hardware, software, or both, and couples the components of the electronic device 600 together. By way of example and not limitation, the bus 604 may be an accelerated graphics port (AGP) or other graphics bus, an enhanced industry standard architecture (EISA) bus, a front side bus (FSB), a hyper transport (HT) interconnect, an industry standard architecture (ISA) bus, an infinite bandwidth interconnect, a low pin count (LPC) bus, a memory bus, a micro channel architecture (MCA) bus, a peripheral component interconnect (PCI) bus, a PCI-Express (PCI-E) bus, a serial advanced technology attachment (SATA) bus, a video electronics standards association local (VLB) bus, or any other suitable bus, or a combination of two or more of the above. Where appropriate, the bus 604 may include one or more buses. Although the embodiment of the present application describes and shows a specific bus, the present application considers any suitable bus or interconnect.

A sixth aspect of the present application provides a system for comparing service parameters. The system for comparing service parameters may include a first device and a second device. The first device may perform the method for comparing service parameters in the embodiments of the first aspect, the second device may perform the method for comparing service parameters in the embodiments of the second aspect, and the both can achieve the same technical effects. To avoid repetition, details will not be repeated here.

A seventh aspect of the present application provides a computer-readable storage medium, the computer-readable storage medium storing computer program instructions, and the computer program instructions, when executed by a processor, implementing the method for comparing service parameters in the embodiments of the first aspect or the method for comparing service parameters in the embodiments of the second aspect, to achieve the same technical effects. To avoid repetition, details will not be repeated here. The computer-readable storage medium may be a non-transient computer-readable storage medium, such as a read-only memory (ROM), a random access memory (RAM), a magnetic disk, or an optical disk.

An embodiment of the present application provides a computer program product, instructions in the computer program product, when executed by a processor of an electronic device, enabling the electronic device to perform the method for comparing service parameters in the embodiments of the first aspect or the method for comparing service parameters in the embodiments of the second aspect, to achieve the same technical effects. To avoid repetition, details will not be repeated here.

It should be noted that the various embodiments in this specification are described in a progressive manner, the same or similar parts between the various embodiments may refer to each other, and each embodiment focuses on the differences from other embodiments. For the embodiments of the first device, the second device, the electronic device, the system, the computer-readable storage medium, and the computer program product, relevant parts may be referenced to the descriptions in the methods of the method. The present application is not limited to the specific steps and structures described above and shown in the figures. Those skilled in the art can make various changes, modifications, and additions, or change the order of steps after understanding the spirit of the present application. And, for the sake of simplicity, detailed descriptions of known methods and technologies are omitted here.

The above describes various aspects of the present application with reference to the flowchart and/or block view of the method, apparatus (system), and computer program product according to the embodiments of the present application. It should be understood that each box in the flowchart and/or block view and a combination of boxes in the flowchart and/or block view can be implemented by computer program instructions. These computer program instructions can be provided to a processor of a general-purpose computer, a dedicated computer, or other programmable data processing apparatuses to produce a machine, which enables the instructions executed by the processor of the computer or other programmable data processing apparatuses to implement the functions/actions specified in one or more boxes of the flowchart and/or block view. Such a processor may be, but is not limited to a general-purpose processor, a dedicated processor, a special application processor, or a field programmable logic circuit. It can also be understood that each box in the block view and/or flowchart and a combination of boxes in the block view and/or flowchart may be implemented by dedicated hardware that executes specified functions or actions, or by a combination of dedicated hardware and computer instructions.

Those skilled in the art should understand that the foregoing embodiments are all illustrative but not restrictive. Different technical features appearing in different embodiments may be combined to achieve beneficial effects. Those skilled in the art should be able to understand and implement other modified embodiments of the disclosed embodiments after studying the drawings, description, and claims. In the claims, the term “comprise” does not exclude other apparatuses or steps; the quantifier “one” does not exclude more; and the terms “first” and “second” are used to denote names rather than to indicate any specific order. Any reference numerals in the claims should not be construed as limiting the scope of protection. The functions of a plurality of portions appearing in the claims can be implemented by a single hardware or software module. The appearance of some technical features in different dependent claims does not mean that these technical features cannot be combined to achieve beneficial effects.

1. A method for comparing service parameters, applied to a first device, the method comprising:
obtaining a first interaction string and a first result string based on a first binary string converted from a first service parameter of the first device, 2^{N} randomly generated first label strings, and 2^{N} initial random strings agreed by the first device and a second device, wherein the first binary string comprises 2^{N} bits, and N is a positive integer;
sending the first interaction string to the second device, so that the second device obtains a second result string based on a second binary string converted from a second service parameter of the second device, the initial random strings, part of randomly generated second label strings, and the first interaction string, wherein the second binary string comprises 2^{N} bits; and
interacting with the second device based on the first result string and the second result string for fragmented computation to obtain a first comparison result, wherein the first comparison result represents whether the first service parameter is equal to the second service parameter.

2. The method according to claim 1, wherein the obtaining a first interaction string and a first result string based on a first binary string converted from a first service parameter of the first device, 2randomly generated first label strings, and 2initial random strings agreed by the first device and a second device comprises:
obtaining the first interaction string by using an XOR algorithm based on the first label strings;
obtaining 2^{N} third label strings by using the XOR algorithm based on the first label strings and the initial random strings, the first label strings representing that values of the corresponding bits in the first binary string are 0, and the third label strings representing that values of the corresponding bits in the first binary string are 1; and
obtaining the first result string based on the first label strings, the third label strings, and the first binary string.

3. The method according to claim 2, wherein the obtaining the first result string based on the first label strings, the third label strings, and the first binary string comprises:
selecting the first label strings and/or third label strings corresponding to the values of the bits in the first binary string; and
obtaining the first result string by using the XOR algorithm based on the selected first label strings and/or third label strings.

4. The method according to claim 1, wherein
the second result string is obtained by the second device based on the second label strings, fourth label strings, and the second binary string,
the second label strings represent that values of the corresponding bits in the second binary string are 0, part of the second label strings are obtained by using the XOR algorithm based on the other part of the randomly generated second label strings and the first interaction string, and
the fourth label strings represent that values of the corresponding bits in the second binary string are 1, and the fourth label strings are obtained by the second device using the XOR algorithm based on the second label strings and the initial random strings.

5. The method according to claim 1, further comprising:
segmenting the first binary string from the middle to obtain two first target strings, wherein the first comparison result represents that the first service parameter is unequal to the second service parameter, and the first target strings comprise a high-order string and a low-order string;
obtaining a target interaction string and a first target result string corresponding to the first target string based on the first target string, and the first label strings and initial random strings corresponding to the first target string;
sending the target interaction string to the second device, so that the second device obtains a second target result string corresponding to a second target string based on the second target string, the target interaction string, and the initial random strings and part of the second label strings corresponding to the second target string, wherein the second target strings comprise a high-order string and a low-order string obtained by segmenting the second binary string from the middle;
interacting with the second device based on the first target result string and the second target result string for fragmented computation to obtain a comparison sub-result, wherein the comparison sub-result represents whether the first target string is equal to the second target string; and
segmenting the first target string from the middle to obtain new first target strings, and obtaining a new comparison sub-result based on the new first target string until the new comparison sub-result represents that the new first target string is equal to the new second target string, or until the new first target string is a binary number and the second comparison result is obtained, wherein the comparison sub-result represents that the first target string is unequal to the second target string, the second comparison result represents that the first service parameter is greater than the second service parameter or the first service parameter is less than the second service parameter.

6. The method according to claim 5, wherein
the new second target string is a binary number, the second label string corresponding to the new second target string is updated by the second device based on the original second label string corresponding to the new second target string and the new target interaction string, and
the fourth label string corresponding to the new second target string is obtained by the second device based on the updated second label string and initial random string corresponding to the new second target string.

7. The method according to claim 1, wherein N≥4.

8. A method for comparing service parameters, applied to a second device, the method comprising:
receiving a first interaction string sent by a first device, wherein the first interaction string is obtained by the first device based on N randomly generated first label strings;
obtaining a second result string based on a second binary string converted from a second service parameter of the second device, initial random strings, part of randomly generated second label strings, and the first interaction string, wherein the second binary string comprises 2^{N} bits, and N is a positive integer; and
interacting with the first device based on a first result string and the second result string for fragmented computation to obtain a first comparison result, wherein the first result string is obtained by the first device based on a first binary string converted from a first service parameter of the first device, the first label strings, and N initial random strings agreed by the first device and the second device, the first comparison result represents whether the first service parameter is equal to the second service parameter, and the first binary string comprises 2^{N} bits.

9. The method according to claim 8, wherein the obtaining a second result string based on a second binary string converted from a second service parameter of the second device, initial random strings, part of randomly generated second label strings, and the first interaction string comprises:
obtaining the other part of second label strings by using an XOR algorithm based on the part of randomly generated second label strings and the first interaction string;
obtaining fourth label strings based on the second label strings and the initial random strings, the second label strings representing that values of the corresponding bits in the second binary string are 0, and the fourth label strings representing that values of the corresponding bits in the second binary string are 1; and
obtaining the second result string based on the second label strings, the fourth label strings, and the second binary string.

10. The method according to claim 9, wherein the obtaining the second result string based on the second label strings, the fourth label strings, and the second binary string comprises:
selecting the second label strings and/or fourth label strings corresponding to the values of the bits in the second binary string; and
obtaining the second result string by using the XOR algorithm based on the selected second label strings and/or fourth label strings.

11. The method according to claim 8, wherein
the first result string is obtained by the first device based on the first label strings, third label strings, and the first binary string,
the first label strings represent that values of the corresponding bits in the first binary string are 0, and
the third label strings represent that values of the corresponding bits in the first binary string are 1, and the third label strings are obtained by the first device using the XOR algorithm based on the first label strings and the initial random strings.

12. The method according to claim 8, further comprising:
segmenting the second binary string from the middle to obtain two second target strings, wherein the first comparison result represents that the first service parameter is unequal to the second service parameter, and the second target strings comprise a high-order string and a low-order string;
receiving a target interaction string sent by the first device, wherein the target interaction string is obtained by the first device based on a first target string, and the first label strings and initial random strings corresponding to the first target string, and the first target strings comprise a high-order string and a low-order string obtained by segmenting the first binary string from the middle;
obtaining a second target result string corresponding to the second target string based on the second target string, the target interaction string, and the initial random strings and part of the second label strings corresponding to the second target string;
interacting with the first device based on the first target result string and the second target result string for fragmented computation to obtain a comparison sub-result, wherein the comparison sub-result represents whether the first target string is equal to the second target string; and
segmenting the second target string from the middle to obtain new second target strings, and obtaining a new comparison sub-result based on the new second target string until the new comparison sub-result represents that the new first target string is equal to the new second target string, or until the new second target string is a binary number and a second comparison result is obtained, wherein the comparison sub-result represents that the first target string is unequal to the second target string, the second comparison result represents that the first service parameter is greater than the second service parameter or the first service parameter is less than the second service parameter.

13. The method according to claim 12, further comprising:
obtaining an updated second label string corresponding to the new second target string based on the original second label string corresponding to the new second target string and the new target interaction string, wherein the new second target string is a binary number; and
obtaining the fourth label string corresponding to the new second target string based on the updated second label string and initial random string corresponding to the new second target string.

14. The method according to claims wherein N≥4.

15. A first device, comprising:
a local computation module, configured to obtain a first interaction string and a first result string based on a first binary string converted from a first service parameter of the first device, 2^{N} randomly generated first label strings, and 2^{N} initial random strings agreed by the first device and a second device, wherein the first binary string comprises 2^{N} bits, and N is a positive integer; and
a communication module, configured to send the first interaction string to the second device, so that the second device obtains a second result string based on a second binary string converted from a second service parameter of the second device, the initial random strings, part of randomly generated second label strings, and the first interaction string, wherein the second binary string comprises 2^{N} bits;
the communication module and the local computation module are further configured to interact with the second device based on the first result string and the second result string for fragmented computation to obtain a first comparison result, wherein the first comparison result represents whether the first service parameter is equal to the second service parameter.

16. (canceled)

17. An electronic device, comprising: a processor and a memory storing computer program instructions, wherein the processor, when executing the computer program instructions, implements the method for comparing service parameters according to any one of claim 1.

18. A system for comparing service parameters, comprising:
a first device, configured to perform the method for comparing service parameters according to claim 1; and
a second device, configured to perform a method for comparing service parameters that is applied to the second device and comprises:
receiving a first interaction string sent by a first device, wherein the first interaction string is obtained by the first device based on N randomly generated first label strings;
obtaining a second result string based on a second binary string converted from a second service parameter of the second device, initial random strings, part of randomly generated second label strings, and the first interaction string, wherein the second binary string comprises 2^{N} bits, and N is a positive integer; and
interacting with the first device based on a first result string and the second result string for fragmented computation to obtain a first comparison result, wherein the first result string is obtained by the first device based on a first binary string converted from a first service parameter of the first device, the first label strings, and N initial random strings agreed by the first device and the second device, the first comparison result represents whether the first service parameter is equal to the second service parameter, and the first binary string comprises 2^{N} bits.

19. A non-transitory computer-readable storage medium, the computer-readable storage medium storing computer program instructions, and the computer program instructions, when executed by a processor, implementing the method for comparing service parameters according to claim 1.
